(19) United States
(12) Patent Application Publication
(10) Pub. No.: US 2026/0074593 A1
(43) Pub. Date: Mar. 12, 2026

(54) Rotating Electric Machine

(71) Applicant: Hitachi Astemo, Ltd., Hitachinaka-shi, Ibaraki (JP)

(72) Inventors: Hideaki GOTO, Hitachinaka-shi, Ibaraki (JP); Yuya OGANE, Hitachinaka-shi, Ibaraki (JP); Akihito TOYA, Hitachinaka-shi, Ibaraki (JP)

(21) Appl. No.: 19/108,466

(22) PCT Filed: Sep. 8, 2022
(86) PCT No.: PCT/JP2022/033753

§ 371 Date: Mar. 4, 2025

(51) Int. Cl. H02K 9/193

(52) U.S. Cl. CPC H02K 9/193

(57) ABSTRACT

A rotating electric machine includes a rotor including a rotor core configured by laminating a plurality of electromagnetic steel plates and a shaft that supports the rotor core, a stator that faces the rotor via an air gap that is a predetermined space, on a radially outer side of the rotor, and a housing that houses the rotor and the stator, in which the housing forms an air flow passage between the rotor and the stator, the shaft includes a shaft flow passage that communicates with the air flow passage, and the rotor includes a pump that is coupled to the shaft and is synchronized with rotation of the shaft and a radial direction flow passage that communicates the shaft flow passage with the air gap.

### TECHNICAL FIELD

The present invention relates to a rotating electric machine.

### BACKGROUND ART

In manufacture of a rotating electric machine, as one method for realizing utilization of a high power density and low grade magnet, a direct oil cooling structure that is one of techniques for cooling the rotating electric machine is adopted. In the direct oil cooling structure, cooling oil is discharged into a motor housing. Then, the cooling oil enters an air gap between a rotor and a stator, an agitation loss is generated, and a motor efficiency is lowered. Therefore, there is a demand for developing a rotating electric machine that prevents the cooling oil from entering the air gap and achieves both of a high cooling performance and a high efficiency.

It is disclosed that a rotating electric machine described in PTL 1 has a structure in which fans 16 and 17 are provided on outer peripheries of end plates 2B and 2C on both sides of a rotor 2, one fan 16 sends air from a space 12A into a gap G, the other fan 17 discharges air from the gap G to a space 12B on a side of the rotor 2, so as to generate a differential pressure by a pump effect caused in a hole provided in the rotor by rotating the motor.

### CITATION LIST

### Patent Literature

PTL 1 Japanese Patent Application Publication No. 2003-250248

### SUMMARY OF INVENTION

### Technical Problem

The technique in PTL 1 reduces an agitation loss by preventing cooling oil from entering into a gap. However, in order to generate a pressure necessary for cooling oil entry prevention in a simple straight flow passage, an effect of reducing the agitation loss cannot be expected in a low and medium speed areas of motor rotation, and high-speed rotation of the motor is needed. Therefore, at the time of high-speed rotation of the motor, since a flow rate of the cooling oil increases, there is a problem in that a pump loss increases.

With the foregoing in view, an object of the present invention is to provide a rotating electric machine that prevents occurrence of an agitation loss of cooling oil in an air gap, from a low-speed area to a high-speed area of a motor rotation speed.

### Solution to Problem

A rotating electric machine includes a rotor including a rotor core configured by laminating a plurality of electromagnetic steel plates and a shaft that supports the rotor core, a stator that faces the rotor via an air gap that is a predetermined space, on a radially outer side of the rotor, and a housing that houses the rotor and the stator, in which the housing forms an air flow passage between the rotor and the stator, the shaft includes a shaft flow passage that communicates with the air flow passage, and the rotor includes a pump that is coupled to the shaft and is synchronized with rotation of the shaft and a radial direction flow passage that communicates the shaft flow passage with the air gap.

### Advantageous Effects of Invention

It is possible to provide a rotating electric machine that prevents occurrence of an agitation loss of cooling oil in an air gap.

### BRIEF DESCRIPTION OF DRAWINGS

FIG. 1 is a configuration diagram of a rotating electric machine, according to an embodiment of the present invention.

FIG. 2 is an explanatory view of an air flow passage in a housing, according to the embodiment of the present invention.

FIG. 3 is an explanatory view of an oil passage in the housing.

FIG. 4 is a Modification 1.

FIG. 5 is a configuration diagram of a pump, according to the embodiment of the present invention.

FIG. 6 is Modifications 2 and 3.

FIG. 7 is a Modification 4.

Hereinafter, an embodiment of the present invention will be described with reference to the drawings. The following description and drawings are examples for describing the present invention, and are omitted and simplified as appropriate for the sake of clarity of description. The present invention can be carried out in various other forms. Unless otherwise specified, each component may be singular or plural.

For easy understanding of the invention, there is a case where a position, a size, a shape, a range, or the like of each component in the drawings does not represent an actual position, size, shape, range, or the like. Therefore, the present invention is not necessarily limited to a position, a size, a shape, a range, or the like disclosed in the drawings.

### Embodiment and Overall Configuration of Present Invention

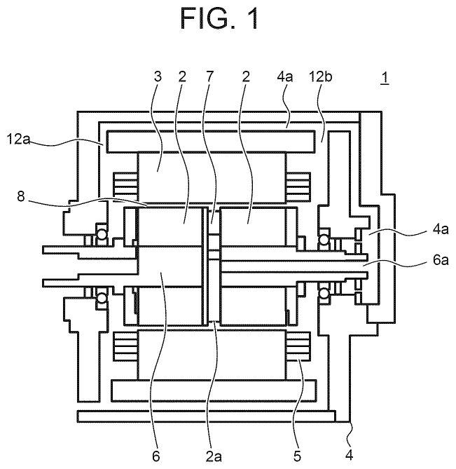

### FIG. 1

A rotating electric machine 1 includes a rotor including a rotor core 2 formed by laminating a plurality of electromagnetic steel plates and a shaft 6 that supports the rotor core 2, a stator 3 (stator core 3) facing the rotor via an air gap 8 that is a predetermined space, on a radially outer side of the rotor core 2, and a housing 4 that houses the rotor and the stator 3. Although not illustrated, a gear coupled to the shaft 6 is provided outside the rotating electric machine 1. In the following description, a gear side is referred to as a left side in the drawing, and a non-gear side is referred to as a right side in the drawing, and these are used for description.

The housing 4 includes an air flow passage 4a between the rotor and the stator 3. In the air flow passage 4a, a passage is formed to communicate from an upper portion of the housing 4 to the non-gear side. The shaft 6 includes a shaft flow passage 6a that communicates with this air flow passage 4a, and is configured to take into air 10 from the non-gear side of the shaft 6. Furthermore, the rotor includes a pump 7 that is coupled to the shaft 6 and is synchronized with rotation of the shaft and a radial direction flow passage 2a that communicates with the shaft flow passage 6a and the air gap 8. Note that, in FIG. 1, an example is illustrated in which the pump 7 is arranged to be sandwiched between the plurality of electromagnetic steel plates.

The pump 7 is coupled to the shaft 6 to rotate together with motor rotation and can generate a centrifugal force. As a result, a differential pressure is generated between the air gap 8 and an inside of the housing 4 other than the air gap 8, and a pressure necessary for preventing cooling oil from entering the air gap 8 can be obtained.

Therefore, an effect of reducing an agitation loss can be obtained. Furthermore, by arranging such a pump 7, it is possible to prevent the cooling oil from entering the air gap 8, in a wide speed area including not only a high-speed area but also a low-speed area, and it is possible to reduce a pump loss in the high-speed area.

Circulation of air in the air flow passage 4a generates an air flow from the air gap 8 toward the housing 4 via the shaft flow passage 6a and the radial direction flow passage 2a communicating with each other. In this way, the cooling oil entered the air flow passage 4a, the shaft flow passage 6a, and the radial direction flow passage 2a is agitated, and it is possible to prevent the cooling oil from entering the air gap 8. Indeed, when a motor rotation speed of the rotating electric machine 1 increases, the agitation loss increases. However, since an increase in an air amount can reduce the agitation loss as a result, it is possible to improve a cooling efficiency of the rotating electric machine 1 and improve a motor efficiency.

Note that, regarding a position of the pump 7, when the pump 7 is provided in the rotor, the pump 7 may be arranged at any position within a range of a length of the air gap 8. Furthermore, the pump 7 may be formed by laminating the electromagnetic steel plates or formed by mixing a resin and a powder magnetic core. The pump 7 avoids occurrence of a loss due to a field of the stator in a case where the pump 7 is made of a simple metal lump, by being formed by mixing the resin and the powder magnetic core.

The radial direction flow passage 2a is formed at the axial center of the rotor core 2. The shaft flow passage 6a is formed from an end of the shaft 6 to a position of the radial direction flow passage 2a in the axial direction. As a result, the shaft flow passage 6a serves as a flow passage in which air flows from the non-gear side of the shaft 6 to the air gap 8 in a communicating manner. Furthermore, by being formed at the position at the axial center of the rotor core 2, the radial direction flow passage 2a generates an air flow toward both ends of the air gap 8 with a minimum flow passage and can prevent the cooling oil from entering the air gap 8.

In the housing 4, a plurality of flow passage holes 12 that communicates with the air flow passage 4a and is formed on a radially outer side in the housing 4 is formed. Among the plurality of flow passage holes 12, a first flow passage hole 12a is formed on a side closer to the gear provided outside the rotating electric machine 1 and a second flow passage hole 12b is formed on a side farther than the first flow passage hole 12a from the gear. Sizes of the first flow passage hole 12a and the second flow passage hole 12b are different. In the drawing, the second flow passage hole 12b is formed to be larger than the first flow passage hole 12a.

In this way, by considering the length of each air flow passage 4a by adjusting the size of the hole so that amounts of air passing through the air gap 8 on the gear side and on the non-gear side match, a pressure loss is managed.

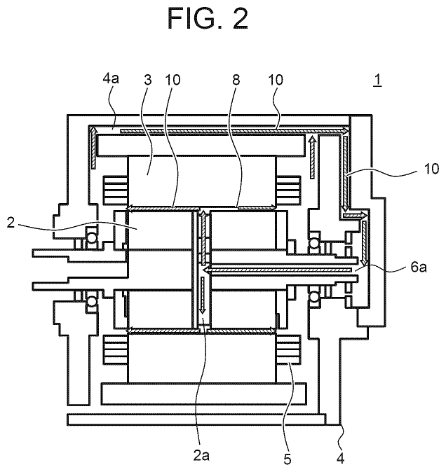

### FIG. 2

A flow of the air 10 is generated by the differential pressure generated by the rotation of the pump 7 described above. As illustrated in the figure, the air circulating in the housing 4 flows first from the flow passage holes 12a and 12b into the air flow passage 4a formed in the above portion of the housing 4 and flows into the shaft flow passage 6a via the air flow passage 4a that communicates with the non-gear side. The air 10 flowing into the shaft flow passage 6a flows into the air gap 8 between the rotor and the stator 3 via the radial direction flow passage 2a. Such circulation of the air 10 can prevent the cooling oil from entering the air gap 8 and solve a conventional problem that cooling oil remains in the air flow passage 4a or the air gap 8.

Note that, although not illustrated, in the housing 4, a cooling oil flow passage may be formed, so as to return the cooling oil flowed into the air flow passage 4a into the housing 4 at a stage before the shaft flow passage 6a. This suppresses a decrease in an air flow amount caused by the cooling oil remaining in the air flow passage 4a. Furthermore, an inlet of the air flow passage 4a may be formed on a side surface of the shaft 6 or the rotor core 2. In a case where the inlet of the air flow passage 4a is provided on the side surface of the shaft 6, a structure of the housing 4 can be simplified, and cost and a size of the rotating electric machine 1 can be reduced, as compared with a case where the inlet is provided on the end of the shaft 6. Furthermore, in a case where the inlet of the air flow passage 4a is provided in the rotor core 2, the remaining cooling oil that cools the rotor core 2 can be reduced.

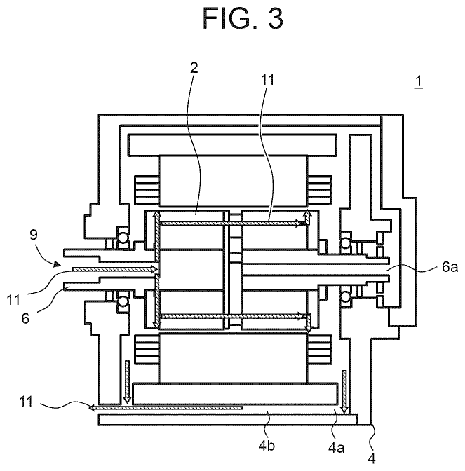

### FIG. 3

The shaft 6 includes a shaft oil passage 9 on the gear side. The shaft oil passage 9 communicates with the oil passage included in the rotor core 2. That is, both of the shaft oil passage 9 through which the cooling oil supplied from the gear side flows and the shaft flow passage 6a that communicates with the air flow passage 4a are provided in the same shaft 6. The cooling oil passing through the shaft oil passage 9 and the rotor core 2 flows toward an oil pan 4b provided in a lower portion of the housing 4, according to gravity after leaving the rotor core 2. Since the oil pan 4b is a part of the air flow passage 4a, the cooling oil is discharged to the outside of the housing 4, by extrusion of the cooling oil by circulation of the air. In this way, oil cooling of the rotating electric machine 1 is performed from the gear side to the non-gear side. In this way, a large heat generation loss in a portion of the rotating electric machine 1 where the field rotates can be reduced.

### Modification 1

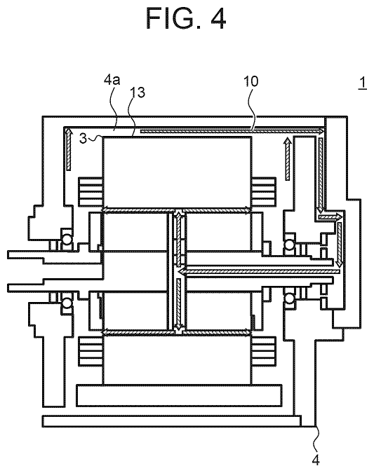

### FIG. 4

For example, since a groove 13 is created as long as the stator core 3 is for by welding, the air flow passage 4a may be formed by the groove 13 such as a positioning groove or a welding groove included in the stator core 3. As a result, the air flow passage 4a provided in the housing 4 can include a small number of parts, and the cost and the size of the rotating electric machine 1 can be reduced.

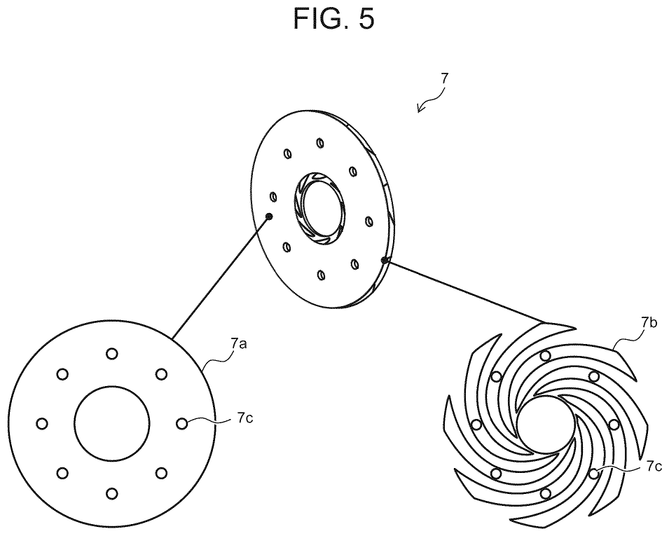

### FIG. 5

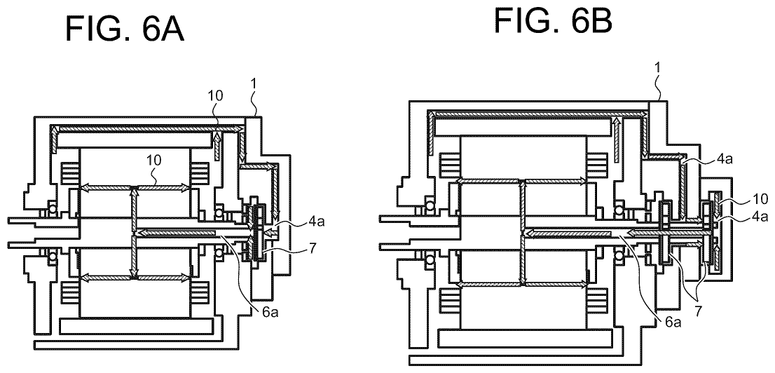

A configuration of the pump 7 will be described. The pump 7 is formed by sandwiching an impeller-shaped steel plate 7b having a plurality of oil passage holes 7c between two circular steel plates 7a having the plurality of oil passage holes 7c. In this way, the pump 7 can be formed at low cost without causing an iron low, by laminating three types of electromagnetic steel plates into an impeller shape. Note that, the pump 7 may be provided on a radially outer side of the rotor core 2, as illustrated in FIG. 6 to be described later, as long as the pump 7 rotates integrally with the shaft 6 for the purpose of miniaturization. In a case where the pump 7 is installed outside a magnetic circuit, since there is no possibility of causing the iron loss, the pump 7 can be formed by pressing. Note that, although the pump 7 can serve as a centrifugal function by providing only one pump 7 for the single rotating electric machine 1, a configuration in which the plurality of pumps 7 is provided may be used.

### Modifications 2 and 3

### FIG. 6

As described above, the pump 7 may be mounted at a position where the pump 7 does not affect the magnetic circuit. For example, as illustrated in FIG. 6(a), the pump 7 is provided at the end of the shaft 6 on the non-gear side, and air may be introduced from the air flow passage 4a to the shaft flow passage 6a. Furthermore, although not illustrated, circulating air may be introduced from the side surface of the rotor core 2, by providing the pump 7 instead of an end plate provided in the rotor core 2.

Furthermore, as illustrated in FIG. 6(b), to cope with reverse rotation of the rotating electric machine 1, the pumps 7 having different discharge directions are provided on each rotation shaft. In this case, in order to prevent air from circulating between the two pumps 7, a backflow prevention valve may be provided at a position between the two pumps 7 on the air flow passage 4a. In this way, by providing the pumps 7 that rotate in reverse directions, it is possible to cope with a change in the flow of the air 10 in the rotating electric machine 1, even at the highest speed in backward traveling of a vehicle, and similarly, the agitation loss can be reduced from the low-speed area to the high-speed area.

### Modification 4

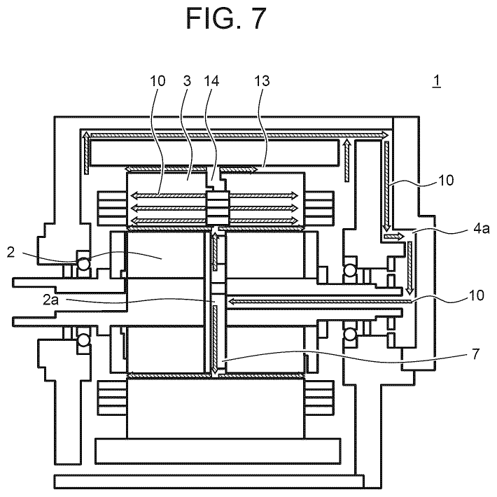

### FIG. 7

The stator core 3 includes a stator cooling flow passage 14. In a case where the rotor is provided in the pump 7, a magnetic circuit portion of the stator 3 corresponding to the pump 7 and the radial direction flow passage 2a of the rotor core 2 is wasted. Therefore, the magnetic circuit portion corresponding to the position of the pump 7 is reduced, and the stator cooling flow passage 14 is provided as a second air flow passage, instead of the magnetic circuit portion. As a result, by flowing the air 10 to the stator core 3 and a coil inserted into the stator core 3, the stator can be cooled.

Furthermore, the stator core 3 forms the stator cooling flow passage 14, for example, by shifting and stacking laminated steel plates having different hole shapes, so that the air 10 passes through while maintaining the inserted coil and its shape.

According to the embodiment of the present invention described above, the following effects are obtained.
(1) The rotating electric machine 1 includes the rotor including the rotor core 2 formed by laminating the plurality of electromagnetic steel plates and the shaft 6 that supports the rotor core 2, the stator facing the rotor via the air gap 8 that is a predetermined space, on the radially outer side of the rotor, and the housing 4 that houses the rotor and the stator. The housing 4 forms the air flow passage 4a between the rotor and the stator, and the shaft 6 includes the shaft flow passage 6a that communicates with the air flow passage 4a. The rotor includes the pump 7 that is coupled to the shaft 6 and is synchronized with the rotation of the shaft 6 and the radial direction flow passage 2a that communicates the shaft flow passage 6a with the air gap 8. This can make it possible to provide the rotating electric machine that prevents the occurrence of the agitation loss of the cooling oil in the air gap.
(2) The pump 7 is arranged to be sandwiched between the plurality of electromagnetic steel plates. In this way, the differential pressure between the air gap 8 and the portion other than the air gap 8 is generated, and the agitation loss is reduced.
(3) The shaft flow passage 6a is formed from the end of the shaft 6 to the position of the radial direction flow passage 2a in the axial direction. In this way, it is possible to reduce the agitation loss of the cooling oil, by sending the air 10 to the air gap 8 via the rotor.
(4) The radial direction flow passage 2a is formed at the position at the axial center of the rotor core 2. In this way, it is possible to generate the air flow toward the both ends of the air gap 8 with the minimum flow passage and to prevent the cooling oil from entering the air gap 8.
(5) The housing 4 includes the cooling oil flow passage for returning the cooling oil that has flowed into the air flow passage 4a, into the housing 4. In this way, the decrease in the air flow amount caused by the cooling oil remaining in the air flow passage 4a is prevented.
(6) Among the plurality of flow passage holes 12 that communicates with the air flow passage 4a and is formed on the radially outer side in the housing 4, the first flow passage hole 12a formed on a side closer to the gear provided outside the rotating electric machine 1 and the second flow passage hole 12b formed on a side farther from the gear than the first flow passage hole 12a have different sizes. In this way, the pressure loss can be managed, in consideration of the length of the air flow passage 4a from each of the flow passage holes 12a and 12b to the shaft flow passage 6a.
(7) The air flow passage 4a is formed by the positioning groove or the welding groove included in the stator. In this way, the air flow passage 4a provided in the housing 4 can include a small number of parts, and the cost and the size of the rotating electric machine 1 can be reduced.
(8) The pump 7 is formed by laminating the electromagnetic steel plates or formed by mixing the resin and the powder magnetic core. In this way, the occurrence of the loss due to the field of the stator in a case where the pump 7 is made of a simple metal lump is avoided.
(9) The inlet of the air flow passage 4a is formed on the side surface of the shaft 6 or the rotor core 2. In this way, it is possible to generate the air flow toward the both ends of the air gap 8 with the minimum flow passage and to prevent the cooling oil from entering the air gap 8.
(10) The stator includes the second radial direction flow passage 14 formed in correspondence with the positions of the pump 7 and the radial direction flow passage 2a. By flowing the air 10 to the stator core 3 and the coil inserted into the stator core 3, the stator can be cooled.

Note that the present invention is not limited to the above embodiment, and various modifications and other configurations can be combined without departing from the gist of the present invention. Note that, the present invention is not limited to one including all the configurations described in the above embodiments, and includes one in which a part of the configuration is deleted.

### Reference Signs List

1 Rotating electric machine
2 Rotor core
2a Radial direction flow passage
3 Stator core
4 Housing
4a Air flow passage
4b Oil pan
5 Coil end
6 Shaft
6a Shaft flow passage
7 Pump
7a Circular steel plate
7b Impeller-shaped steel plate
7c Oil passage hole
8 Air gap
9 Shaft oil passage
10 (flow of) Air
11 (flow of) Cooling oil
12a, 12b Flow passage hole
13 Groove
14 Stator cooling flow passage (second radial direction flow passage)

1. A rotating electric machine comprising:
a rotor including a rotor core configured by laminating a plurality of electromagnetic steel plates and a shaft that supports the rotor core;
a stator that faces the rotor via an air gap that is a predetermined space, on a radially outer side of the rotor; and
a housing that houses the rotor and the stator, wherein
the housing forms an air flow passage between the rotor and the stator,
the shaft includes a shaft flow passage that communicates with the air flow passage, and
the rotor includes a pump that is coupled to the shaft and is synchronized with rotation of the shaft and a radial direction flow passage that communicates the shaft flow passage with the air gap.

2. The rotating electric machine according to claim 1, wherein
the pump is arranged to be sandwiched between the plurality of electromagnetic steel plates.

3. The rotating electric machine according to claim 1, wherein
the shaft flow passage is formed from an end of the shaft to a position of the radial direction flow passage in an axial direction.

4. The rotating electric machine according to claim 1, wherein
the radial direction flow passage is formed at a position at an axial center of the rotor core.

5. The rotating electric machine according to claim 1, wherein
the housing includes a cooling oil flow passage for returning cooling oil that has flowed into the air flow passage, into the housing.

6. The rotating electric machine according to claim 1, wherein
a first flow passage hole that communicates with the air flow passage and is formed on a side closer to a gear provided outside the rotating electric machine, among a plurality of flow passage holes formed on a radially outer side in the housing, and a second flow passage hole that is formed on a side farther from the gear than the first flow passage hole have different sizes.

7. The rotating electric machine according to claim 1,
the air flow passage is formed by a positioning groove or a welding groove included in the stator.

8. The rotating electric machine according to claim 1, wherein
the pump is formed by laminating the electromagnetic steel plates or formed by mixing a resin and a powder magnetic core.

9. The rotating electric machine according to claim 1, wherein
an inlet of the air flow passage is formed on a side surface of the shaft or the rotor core.

10. The rotating electric machine according to claim 1, wherein
the stator includes a second radial direction flow passage formed in correspondence with positions of the pump and the radial direction flow passage.
